(19) United States
(12) Patent Application Publication
(10) Pub. No.: US 2004/0247084 A1
(43) Pub. Date: Dec. 9, 2004

(54) Cleansing member for image scanning assemblies

(76) Inventor: Edgar Alzner, Garden City, NY (US)

Correspondence Address: CLIFFORD G. FRAYNE, Suite 7A, 136 Drum Point Road, Brick, NJ, 08723, US

(21) Appl. No.: 10/850,545

(22) Filed: May 20, 2004

Related U.S. Application Data
(60) Provisional application No. 60/472,665, filed on May 23, 2003.

(51) Int. Cl. G03B 42/04

(52) U.S. Cl. 378/184; 250/589; 15/208; 15/104.2

(57) ABSTRACT

These and other objects of the present invention are attained by a cleansing member comprised of a flexible substrate having collection layers formed on one or both sides thereof having an adhesive capability of capturing dust, particulate material and the like, along the transport assembly of an image scanning assemblies. In one embodiment, the cleansing member is dimensioned to conform to intraoral image sized plates. In one embodiment the collection layer is tacky and is provided with a protective layer facily removed prior to use. To facilitate handling of the cleansing member, each collection layer is preferably of a length slightly less than the length of the cleansing member.

### RELATED APPLICATIONS

Applicant claims the benefit of provisional application Ser. No. 60/472,665, filed May 23, 2003.

### BACKGROUND OF THE INVENTION

1. Field of the Invention

This invention relates to imaging scanning, and more particularly to a cleansing member for imaging scanning assemblies.

2. Description of the Prior Art

In dental technology, intraoral x-ray images have traditionally been obtained by placing x-ray film in the patient's oral cavity behind the tooth or teeth to be imaged. Dental technology, inter alia, is now in the age of digital imaging and one such system is based upon the use of photo-stimulable phosphor (PSP) imaging plates.

In U.S. Pat. No. 6,599,014 to Thoms, there is disclosed a device for reading a flexible storage foil including PSP imaging plates wherein a transport assembly is comprised of a plurality of roller assemblies for moving a flexible storage foil passed by an interrogation reading light beam rotating about an axis perpendicular to the movement of the flexible storage foil.

Digital imaging reading or scanning of an imaging plate is effected by the build-up of dust, particulate matter and the like in the path or track of the transport assembly. Build-up of dust, particulate matter and the like may effect image interrogation and thus resulting information to be stored and subsequently viewed during evaluation of such information.

### OBJECTS OF THE INVENTION

An object of the present invention is to provide a cleansing member for image scanning assemblies.

Another object of the present invention is to provide a cleansing member for image scanning assemblies dimensioned to intraoral imaging plates.

Still another object of the present invention is to provide a cleansing member for image scanning assemblies which is facily inserted into transport assemblies of image scanning assemblies.

### SUMMARY OF THE INVENTION

These and other objects of the present invention are attained by a cleansing member comprised of a flexible substrate having tacky layers or a velvet-like surface layer formed on either or both sides thereof as more fully hereinafter described having an adhesive capability of capturing dust, particulate material and the like, along the transport assembly of image scanning assemblies. In one embodiment, the cleansing member is dimensioned to conform to intraoral image sized plates. Each tacky layer of the cleansing member is provided with a protective layer facily removed prior to use, and each velvet-like surface layer would be individually packaged. To facilitate handling of the cleansing member, each tacky or velvet-like layer is preferably of a length slightly less than the length of the cleansing members providing edgewise handling of the cleansing member.

### BRIEF DESCRIPTION OF THE DRAWINGS

These and other advantages of the present invention will become more readily apparent from the following detailed description thereof, particularly when taken with the following drawings wherein:

FIG. 1 is a perspective view of an image scanning assembly in a dental configuration;

FIG. 2 is a partial enlarged view of the image scanning assembly of FIG. 1 illustrating the intraoral image plate positioning member;

FIG. 3 is an exploded isometric view of a cleansing member of the present invention;

FIG. 4 is an end view of the cleansing member of the present invention; and

FIG. 5 is an exploded view of a second embodiment of the cleansing member of the present invention.

### DETAILED DESCRIPTION OF THE INVENTION

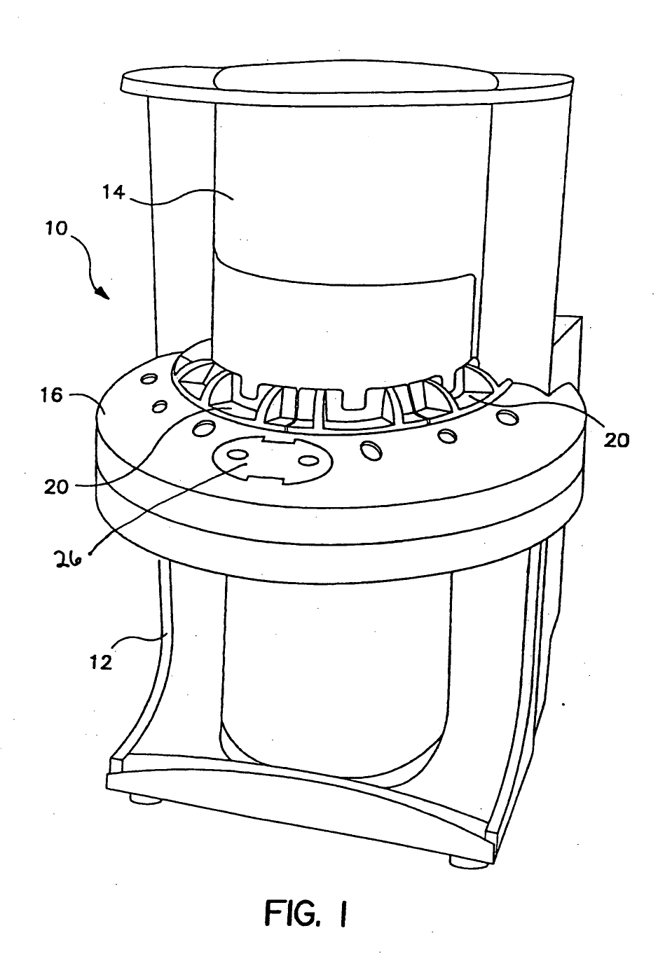

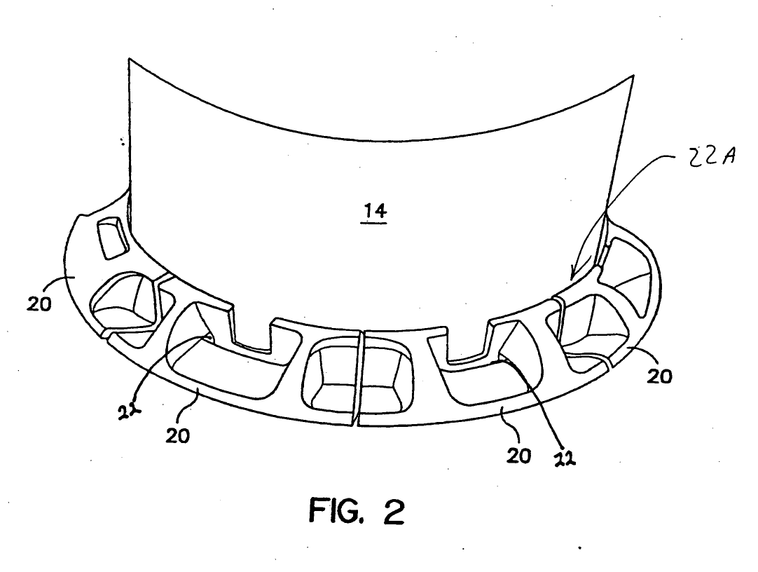

Referring now to FIGS. 1 and 2 there is illustrated an image scanning assembly in a dental configuration, generally indicated as 10, and comprised of a frame 12, an inlet feed cylinder 14, and a transport arch cover 16.

The image scanning assembly 10 is in vertical orientation as compared to the image scanning assembly as hereinabove described with reference to U.S. Pat. No. 6,599,014 to Thoms. The transportation arch cover 16 encloses a transport assembly including a plurality of roller assemblies (not shown). In a dental configuration for scanning intraoral imaging plates, the image scanning assembly 10 is provided with a plurality of image plate positioning members 20 including slots 22 in alignment with roller assemblies of the transport assembly for the insert and transport of intraoral imaging plates. The slot 22A circumferentially formed about the feed cylinder 14 provides for the insertion and interrogation of what are referred to in the dental arts as panoramic imaging plates (see FIG. 3). An on/off switch assembly generally indicated as 26 is positioned on the front of the arch cover 16.

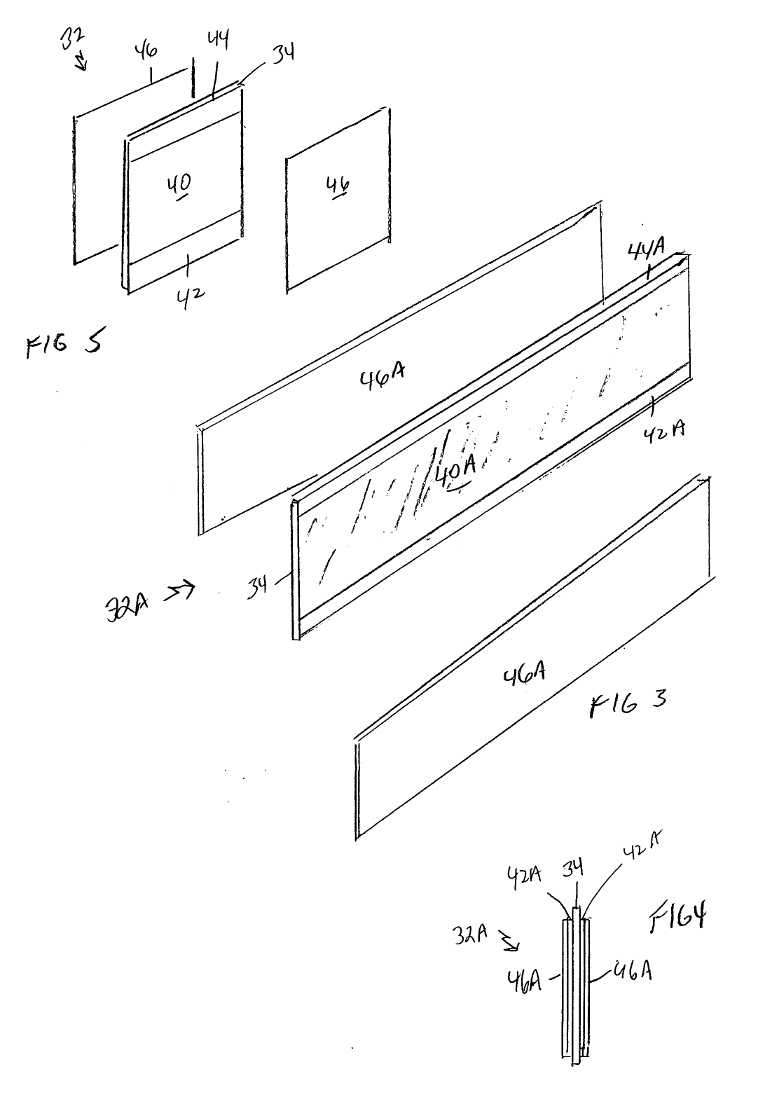

Over the course of time, dust, dirt and like particulate matter materials accumulate within the transport assembly and interfere with scanning and reading of imaging plates. In accordance with the present invention, a cleansing member, generally indicated at 32 or 32A, referring now to FIGS. 3, 4 and 5, is inserted into a slot 22 or 22A and is caused to traverse the transport assembly and clean the transport and scanning areas of the scanner by accumulating such dust, dirt and like particulate matter accumulated therein.

Cleansing member 32A is representative of what would be referred to as a panoramic cleansing member for the panoramic imaging plate path which commences with slot 22A. The cleansing member 32 illustrated in FIG. 5 is representative of a standard intraoral imaging plate which would be introduced into the transport system by means of slots 22. Cleansing members 32 and 32A perform in this same fashion and the description of their structure and use will be explained with respect to cleansing member 32.

The cleansing member 32 is formed of a flexible substrate 34 of a thickness slightly less than the thickness of an imaging plate. To each or only one side of the flexible substrate 34 there is provided a layer or film 40 of an adhesive like material similar to that of a self-sticking note pad or velvet-like material such as flock paper. A width of each tacky or velvet-like layer or film 40 is applied to one or both sides of the substrate in a dimension less than the length of the flexible substrate leaving a non-tacky margin area 42 and 44 at the upper and lower ends of cleansing member 32. The tacky layer of adhesive 40 is covered with a peel off layer 46 to facilitate handling prior to usage, and the velvet-like layer is uncovered except for its delivery container.

In operation, a cleansing member 30 is introduced into the image scanning assembly 10 to follow the path or route of an intraoral imaging plate being scanned by the assembly to collect dust, dirt, debris and like particulate matter. After traversal, the cleansing member 30 is discarded. If the cleansing member is coated only on one side, two such cleansing members are needed to clean both sides of the transport slot or if the cleansing member is not too soiled after the first pass through the transport system, it may be used, buy only a second time for cleaning the other side of the transport slot by reversing its entry into the transport slot.

While the present invention has been described with reference to dental applications regarding the scanning of intraoral imaging plates, it will be understood by one skilled in the art that the positioning members may be removed and the image scanning assembly used to scan larger imaging plates up to the full width of the feed cylinder 14 and in such configuration, a cleansing member of the type described would be utilized corresponding to the width of the feed cylinder corresponding to the maximum width of the imaging plates being scanned.

While the present invention has been described with respect to the exemplary embodiments thereof, it will be recognized by those of ordinary skill in the art that many modifications or changes can be achieved without departing from the spirit and scope of the invention. Therefore it is manifestly intended that the invention be limited only by the scope of the claims and the equivalence thereof.

What is claimed is:

1. A cleansing member for a transport assembly of an image scanning assembly, which comprises a flexible substrate having a collection layer disposed on either side thereof.

2. The cleansing member for a transport assembly of an image scanning assembly as defined in claim 1 wherein said collection layer comprises a tacky adhesive.

3. The cleansing member for a transport assembly of an image scanning assembly in accordance with claim 1 wherein said collection layer comprises a velvet-like layer comprising flock paper.

4. The cleansing member for a transport assembly of an image scanning assembly in accordance with claim 1 wherein said cleansing member is opaque.

5. The cleansing member for a transport assembly of an image scanning assembly as defined in claim 2 and further including a protective layer covering said layer of tacky adhesive disposed on either side of said flexible substrate.

6. The cleansing member for a transport assembly of an image scanning assembly as defined in claim 2 wherein a length of said collection layer is less that a length of said flexible substrate.

7. The cleansing member for a transport assembly of an image scanning assembly as defined in claim 1 wherein said flexible substrate is of a thickness slightly less than a thickness of intraoral imaging plate.

8. The cleansing member for a transport assembly of an image scanning assembly as defined in claim 7 wherein a width of said flexible substrate corresponds to a maximum width of an intraoral imaging plate.
